(19) United States
(12) Patent Application Publication
(10) Pub. No.: US 2005/0152409 A1
(43) Pub. Date: Jul. 14, 2005

(54) Method of increasing channel capacity of FFT and IFFT engines

(75) Inventors: Ping-Ya Zhao, Kanata (CA); Yunjun Zhang, Ottawa (CA)

Correspondence Address: MARKS & CLERK, P.O. BOX 957, STATION B, OTTAWA, ON, K1P 5S7, CA

(73) Assignee: 1021 Technologies Inc., Kanata (CA)

(21) Appl. No.: 10/975,348

(22) Filed: Oct. 29, 2004

Related U.S. Application Data
(60) Provisional application No. 60/515,658, filed on Oct. 31, 2003.

(51) Int. Cl. H04J 3/04

(52) U.S. Cl. 370/535

(57) ABSTRACT

In order to increase channel capacity of a processing engine in a telecommunication network, separate telecommunication signals are multiplexed in pairs to produce at least one multiplexed signal. This signal is transmitted to the processing engine to create a processed multiplexed signal. The processed multiplexed signal from the processing engine is then demultiplexed to produce separate processed telecommunication signals.

### CROSS REFERENCE TO RELATED APPLICATION

This application claims the benefit under 35 USC 119(e) of prior U.S. provisional application Ser. No. 60/515,658 filed on Oct. 31, 2003, the contents of which are herein incorporated by reference.

### FIELD OF THE INVENTION

The present invention relates to System-on-a-Chip (SoC) implementation of a variety of communication systems. More specifically, the invention relates to a method of increasing the channel capacity of Inverse Fast Fourier Transform (IFFT) and the Fast Fourier Transform (FFT) engines without increasing die size of the chip.

In the first and last mile connections of telecommunication networks, various Digital Subscriber Line (xDSL) and wireless technologies play a dominate role. These technologies are usually based on a common fundamental technology: Discrete multitone (DMT) in xDSL or Orthogonal Frequency-Division Multiplexing (OFDM) in wireless. DMT and OFDM both use many narrow-band carriers all being transmitted simultaneously. Each narrow band or frequency bin carries part of the total information. Each of these narrow-bands is independently modulated—with a carrier frequency corresponding to the centre frequency of that bin—all bins are processed in parallel.

The centre of the DMT/OFDM technology is the IFFT and the FFT which perform the independent modulations and demodulations. In a SoC implementation of the xDSL or wireless modem, about 80-90% of the gates are for the implementation of the IFFT and FFT.

The customers of the first and last mile connections of a telecommunication network are end consumers, and they are very sensitive to pricing. Therefore, the first and last mile connection equipment must be manufactured to keep the lowest production cost possible in order to result in a reasonable profit on their sales.

In the semiconductor manufacture business, the cost of wafers is a major item in calculating the Bill of Material (BOM) cost. If a wafer can be divided into more dies during the semiconductor fabrication process, the per die BOM will be reduced. If a die can host more channels without increasing its size, the per channel BOM will also be reduced.

As the majority of the SoC die size is dedicated to the IFFT and FFT engines for the above applications, the per channel die size can be reduced by almost 50% if the channel capacity of the IFFT and FFT engines with the same clock rate and the same semiconductor fabrication process can be doubled.

### SUMMARY OF THE INVENTION

The present invention relates to the System-on-a-Chip (SoC) implementation of a variety of communication systems, such as Very-high-bit-rate Digital Subscriber Line (VDSL), Asymmetric Digital Subscriber Line (ADSL) Transceivers family and any other systems employing Discrete multitone (DMT) or Orthogonal frequency-division multiplexing (OFDM) technology in base band.

Specifically, a method to increase, and in particular, double the channel capacity of the IFFT and FFT engines with the same clock rate and a similar number of gates on the silicon is disclosed. By using linear and symmetric properties of the FFT and IFFT, only one IFFT and one FFT engine is required to process two separate signals. Therefore, the per channel die size of the engine implementations in a SoC is cut by half.

Thus, according to one aspect, the invention provides a method of increasing channel capacity of a processing engine in a telecommunication network, the method comprising the steps of multiplexing separate telecommunication signals in pairs to produce at least one multiplexed signal; transmitting the multiplexed signal to the processing engine to create a processed multiplexed signal; and demultiplexing the processed multiplexed signal from the processing engine to produce separate processed telecommunication signals.

Another aspect of the invention provides a transmitter for a multi-carrier communications system comprising first and second input ports for respective first and second data streams; a multiplexer for combining said first and second data streams into a common data stream; a common inverse transform engine for performing an inverse transform operation on said common data stream; a demultiplexer for separating said common data stream into first and second output data streams; and first and second output ports for transmitting said output data streams on respective physical channels.

In yet another aspect the invention provides a receiver for a multi-carrier communications system comprising first and second input ports for receiving first and second input signals on respective physical channels; a multiplexer for combining said first and second input signals into a common data stream; a common transform engine for performing an transform operation on said common data stream; a demultiplexer for separating said transformed data stream into first and second output data streams; and first and second output ports for outputting said data streams.

Other aspects and advantages of embodiments of the invention will be readily apparent to those ordinarily skilled in the art upon a review of the following description.

### BRIEF DESCRIPTION OF THE DRAWINGS

The invention will now be described in more detail, by way of example only, with reference to the accompanying drawings, in which:—

FIG. 1 is a schematic illustration of a prior art DMT/OFDM transmitter;

FIG. 2 is a schematic illustration of a prior art DMT/OFDM receiver;

FIG. 3 is a schematic illustration of a DMT/OFDM transmitter in accordance with principles of the present invention;

FIG. 4 is a schematic illustration showing how two independent signals can be combined, processed by one single IFFT engine and separated into two channels at the transmitter side;

FIG. 5 is a schematic illustration showing of a DMT/OFDM receiver in accordance with principles of the present invention; and

FIG. 6 is a schematic illustration showing how two independent signals can be combined, processed by one single FFT engine and separated at the receiver side.

### DETAILED DESCRIPTION OF THE PREFERRED EMBODIMENTS

The invention makes use of the linear and symmetric properties of the FFT and IFFT.

Let {x₁(k)} and {x₂(k)} be two 2N×1 real vectors, where N is an integer, and
{x(k)}={x(k)}+j{x₂(k)} (Equation 1)
Further let
{x(n)}=FFT{x(k)} (Equation 2)
then

$$\begin{matrix}\begin{matrix}\{ X ( n ) \} = FFT ( \{ {x}_{1} ( k ) \} + j \{ {x}_{2} ( k ) \} ) \\ = FFT \{ {x}_{1} ( k ) \} + j FFT \{ {x}_{2} ( k ) \} \\ = \{ {X}_{1} ( n ) \} + j \{ {X}_{2} ( n ) \}\end{matrix} & ( Equation 3 ) \\ \begin{matrix}\{ {X}_{1} ( n ) \} = FFT \{ {x}_{1} ( k ) \} + FFT \{ Re \{ {x}_{} ( k ) \} \} \\ = \frac{1}{2} [ \{ X ( n ) \} + \{ {X}^{*} ( N - n ) \} ] \\ and\end{matrix} & ( Equation 4 ) \\ \begin{matrix}\{ {X}_{2} ( n ) \} = FFT \{ {x}_{2} ( k ) \} + FFT \{ Im \{ {x}_{} ( k ) \} \} \\ = \frac{1}{2 j} [ \{ X ( n ) \} - \{ {X}^{*} ( N - n ) \} ] ,\end{matrix} & ( Equation 5 )\end{matrix}$$

where X*(n) is the complex conjugate of X(n).

Using the above linear property, in accordance with the principles of the invention in the transmitter side two separate signals are combined before being sent to a single IFFT engine. The single output of the IFFT engine is separated and transmitted to two physical channels. Because only one IFFT engine is required to process two separate signals to be transmitted as opposed to two IFFT engines in the prior art, the per-channel die size of IFFT engine implementation in a SoC is cut by half.

Similarly, by using the above symmetric property of FFT, in the receiver side, two separate signals received from two physical channels are combined before being sent to a single FFT engine for demodulation. The output of the FFT engine is separated and demapped to restore the two independent data streams. Because only one FFT engine is required to process two signals received from two separate physical channels as opposed to two FFT engines in the prior art, the per-channel die size of FFT engine implementation in a SoC is cut by half.

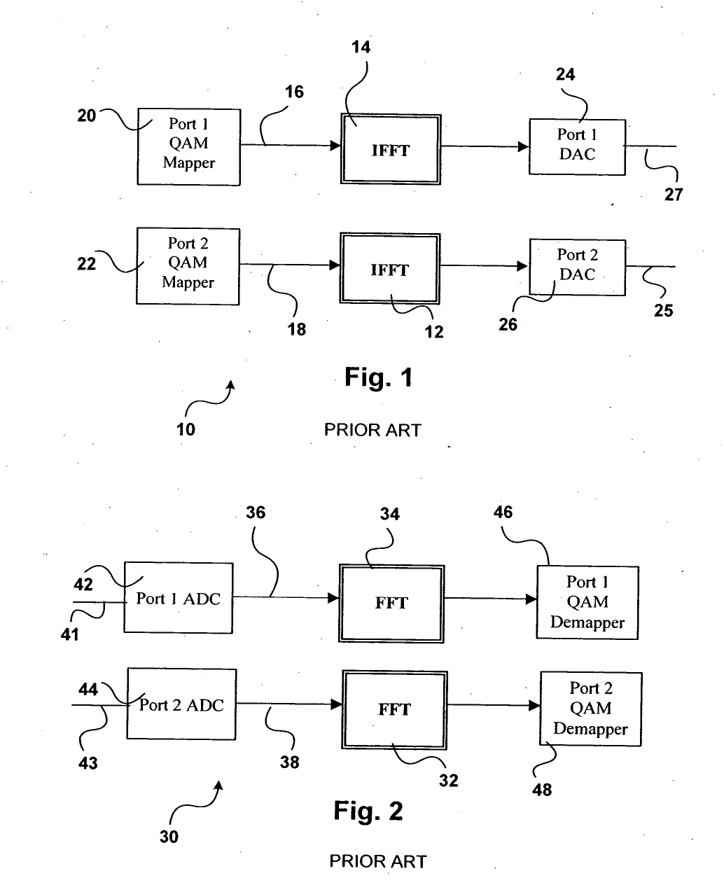

Referring to FIG. 1, there is shown a schematic illustration of a prior art DMT/OFDM transmitter 10. The transmitter 10 requires two IFFT engines 12 and 14 to modulate two data streams 16 and 18 transmitted to two separate physical channels from QAM mappers 20 and 22. Normally, DMT completes the modulation process by performing IFFT operations on complex vectors {X₁(n)}, and {X₂(n)}, and two real vectors {x₁(k)} and {x₂(k)} are generated. These two real vectors are then sent to digital to analog converters (DACs) in ports 24 and 26 before being sent out on two separate physical channels 25, 27.

Let {X′₁(n)} be an N×1 complex vector of such a batch of the complex numbers from channel 1 and {X′₂(n)} be another N×1 complex vector of such a batch of the complex numbers from channel 2. {X′(n)} and {X′₂(n)} are expanded to 2N×1 complex vectors {X₁(n)} and {X₂(n)} as follows:

$${X}_{i} ( n ) = \{ \begin{matrix}{X}_{i}^{′} ( n ) & n = 0 , … , N - 1 \\ {X}_{i}^{′} ( 2 N - n ) & n = N , … , 2 N - 1\end{matrix} \\ i = 1 , 2 \qquad ( Equation 6 )$$

In the prior art, shown in FIG. 1, the DMT completes the modulation process by performing IFFT operations on {X(n)} and {X₂(n)} and two real 2N×1 real vectors {x₁(k)} and {x₂(k)} are generated
{x₁(k)}=Re{IFFT{X₁(n)}} (Equation 7)
{x₂(k)}=Re{IFFT{X₂(n)}} (Equation 8)

These two real vectors are then sent to digital to analog converters in ports 24, 26 before being sent to the two separate physical channels. Two separate IFFT operations are required and hence two IFFT engines need to be implemented in a SoC silicon if the SoC is to process two channels.

In the above process, two IFFT operations are required and hence two IFFT engines need to be implemented in a SoC silicon if the SoC is to process two channels. If the channel size is to be increased, the die size must also be increased accordingly.

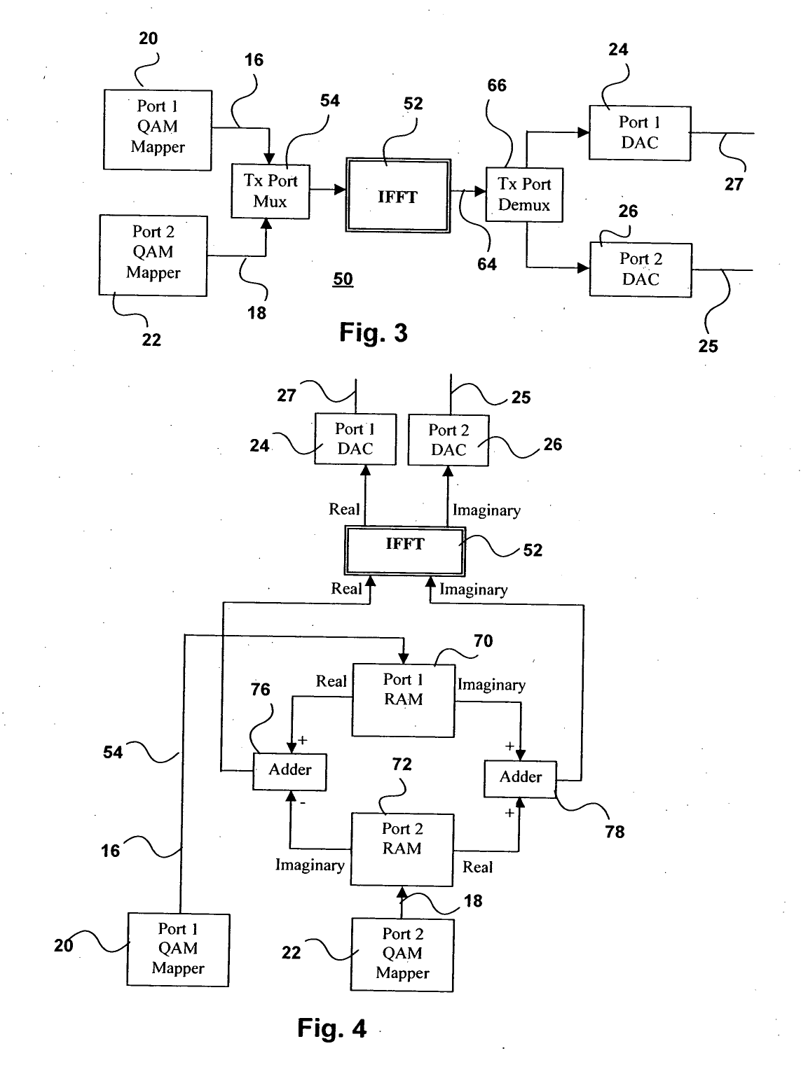

FIG. 3 is a schematic illustration showing a DMT/OFDM transmitter 50 with only one IFFT engine 52 to modulate two data streams before being transmitted to two separate physical channels 68, 70.

Using the linear properties outlined above in the transmitter side 50 two separate signals 18 and 16 sent from QAM mappers 20 and 22 are combined by Tx Port Mux 54 before being sent to a single IFFT engine 52. The single output 64 of the IFFT engine 52 is separated by Tx Port Demux 66 and transmitted to the digital-to-analog converters (DAC) of Ports 24, 26, and then to the two physical channels 25 and 27.

The incoming data stream is mapped to a sequence of complex numbers according to the constellation diagrams. The sequence of the complex numbers is then divided into batches of N=2^{M} in length, where M is an integer.

In accordance with the principles of the invention {X₁(n)} and {X₂(n)} are combined into one 2N×1 complex vector {X(n)} as follows:
{X(n)}={X₁(n)}+j{X₂(n)} (Equation 9)
and the resulting 2N×1 complex vector {X(n)} is sent to one single IFFT engine 52. Equation 9 is the mathematical function performed in the Tx Port Mux module 62. The output of this single IFFT engine 52 is a complex 2N×1 complex vector {x(k)},
{x(k)}=IFFT{X(n)}. (Equation 10)

Two real 2N×1 real vectors {x₁(k)} and {x₂(k)} are generated by
{x(k)}=Re{x(k)} (Equation 11)
{x₂(k)}=Im{x(k)} (Equation 12)
in the Tx Port Demux module 66 and are then sent to digital to analog converters in ports 24, 26 before being sent to two separate physical channels 68, 70.

FIG. 4 is a schematic illustration showing how the two independent signals 16 and 18 from port mappers 20, 22 are combined, processed by one single IFFT engine 52 and separated into two channels 68 and 70 at the transmitter side 50. The output of QAM port mappers 20, 22 are sent respectively to RAMs 70, 72. The real and imaginary parts from the RAMs 70, 72 are added in respective adders 76, 78 and passed to IFFT 52 before being input to the DACs of ports 22, 24. In FIG. 4 the demux 66 is presumed to be included in the IFFT block 52.

In further embodiments, there could be other system specific functional blocks, such as Peak to Average Ratio reducers, between IFFT output port and DACs.

Because only one IFFT engine 52 is required to process two separate signals to be transmitted as opposed to two IFFT engines in the prior art, the per-channel die size of IFFT engine implementation in a SoC is cut by half.

FIG. 2 shows a schematic illustration of a prior art DMT/OFDM receiver 30 requiring two FFT engines 32 and 34 to demodulate two signals 36 and 38 received from two separate physical channels 41, 43. In this system, real vectors {x(k)} and {x₂(k)} are fed from analog to digital converters (ADCs) 42 and 44 to two separate FFT engines 32 and 34, and two complex vectors {X₁(n)} and {X₂(n)} are generated. The first halves of {X(n)} and {X₂(n)} are sent to QAM demappers in ports 46 and 48 to de-modulate and restore the data streams transmitted from two independent sources.

Let {x(k)} be a 2N×1 real vector of such a batch of the digital signal from channel 1 and {x₂(k)} be another 2N×1 real vector of such a batch of the digital signal from channel 2. In the prior art {x(k)} and {x₂(k)} were fed to two separate FFT engines as shown in FIG. 2 and two 2N×1 complex vectors {X(n)} and {X₂(n)} were generated as follows:
{X₁(n)}=FFT{x₁(k)} (Equation 13)
{X₂(n)}=FFT{x₂(k)}. (Equation 14)

The first halves of {X₁(n)} and {X₂(n)} were sent to QAM demappers in ports 46, 48 to de-modulate and restore the data streams transmitted from two independent sources. If the channel size is to be increased, the die size must also be increased accordingly.

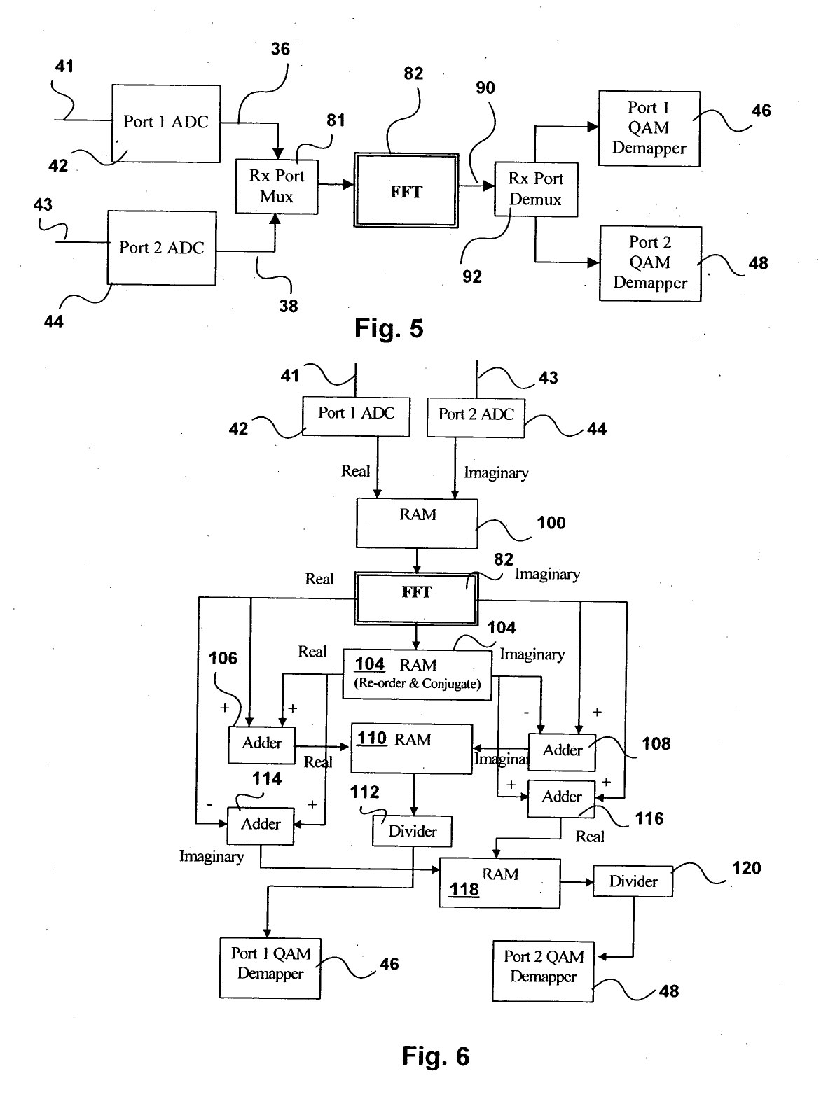

FIG. 5 is a schematic illustration showing that in accordance with the principles of the present invention a DMT/OFDM receiver 80 requires only one FFT engine 82 to demodulate two signals 36 and 38 received from two separate physical channels 41, 43. By using the above symmetric property of FFT, in the receiver side, two separate signals 36 and 38 received from two physical channels are combined by Rx Port Mux 81 before being sent to the single FFT engine 82 for demodulation. The output 90 of the FFT engine 82 is separated by Rx Port Demux 92 and demapped at QAM demappers 46 and 48 to restore the two independent data streams.

In accordance with the principles of the invention {x₁(k)} and {x₂(k)} are combined to create a 2N×1 complex vector {x(k)}:
{x(k)}={x₁(k)}+j{x₂(k)} (Equation 15)
in the Rx Port Mux module 81 as shown in FIG. 5 and this {x(k)} is sent to the single FFT engine 82 resulting in a 2N×1 complex vector {X(n)} as follows:
{X(n)}=FFT{x(k)} (Equation 16)
From {X(n)}, two N×1 vectors {X′₁(n)} and {X′₂(n)} are created with their elements being

$$\begin{matrix}{X}_{1}^{′} ( n ) = \\ \{ \begin{matrix}\frac{1}{2} [ X ( 0 ) + {X}^{*} ( 0 ) ] & n = 0 \\ \frac{1}{2} [ X ( n ) + {X}^{*} ( 2 N - n ) ] & n = 1 , … , N - 1\end{matrix} & ( Equation 17 ) \\ {X}_{2}^{′} ( n ) = \\ \{ \begin{matrix}\frac{1}{2 j} [ X ( 0 ) - {X}^{*} ( 0 ) ] & n = 0 \\ \frac{1}{2 j} [ X ( n ) - {X}^{*} ( 2 N - n ) ] & n = 1 , … , N - 1\end{matrix} & ( Equation 18 )\end{matrix}$$

Equations 17 and 18 are the mathematical functions performed in the Rx Port Demux module 92. {X′(n)} and {X′₂(n)} are sent to QAM demappers in ports 46, 48 to de-modulate and restore the data streams transmitted from two independent sources.

FIG. 6 is a schematic illustration showing how two independent signals can be combined, processed by one single FFT engine 82 and separated at the receiver side. The signals from ports 42, 44 are passed through RAM 100 to FFT 82, which generates real and imaginary parts 100, 102. The output of the FFT is also applied to Reoorder and Conjugate RAM 104. The real and imaginary outputs from FFT 82 and RAM 104 are applied to respective adders 106, 108 and input to RAM 110, which divider 112 that provides the output to port 46.

The real and imaginary outputs from FFT 82 and RAM 104 are also applied to adders 114, 116 whose outputs are applied to RAM 118, which supplies the data stream to port 48 through divider 120.

The analog signals from two separate channels 41, 43 are converted to digital signals by the Analog to Digital Converters (ADC) in ports 42, 44. The digital signals are then divided into batches of 2N=2^{M+1} in length.

It will be seen that in the above embodiment only one FFT engine is required to de-modulate signals from two separate channels.

Numerous modifications may be made without departing from the spirit and scope of the invention as defined in the appended claims.

1. A method of increasing channel capacity of a processing engine in a telecommunication network, the method comprising the steps of:
multiplexing separate telecommunication signals in pairs to produce at least one multiplexed signal;
transmitting the multiplexed signal to the processing engine to create a processed multiplexed signal; and
demultiplexing the processed multiplexed signal from the processing engine to produce separate processed telecommunication signals.

2. The method of claim 1, wherein the processing engine is an Inverse Fast Fourier Transform engine (IFFT).

3. The method of claim 2, wherein the step of multiplexing includes the steps of:
mapping each signal of each pair to a sequence of complex numbers;
dividing the sequence of complex numbers into batches to create pairs of complex vectors;
combining each pair of complex vectors to produce one multiplexed signal.

4. The method of claim 3, wherein the step of demultiplexing includes generating two real vectors in the demultiplexer.

5. The method of claim 4, further comprising the step of transmitting each real vector to a digital-to-analog converter.

6. The method of claim 3, wherein the mapping step uses QAM.

7. The method of claim 1, wherein the processing engine is a Fast Fourier Transform engine (FFT).

8. The method of claim 7, wherein the step of multiplexing includes the steps of:
dividing the signals into batches of real vectors; and
combining each pair of real vectors to produce one multiplexed signal.

9. The method of claim 8, wherein the step of demultiplexing includes generating two complex vectors from each signal, and
demapping each complex vector to produce a telecommunication signal.

10. The method of claim 9, wherein the demapping step uses QAM.

11. A transmitter for a multi-carrier communications system comprising:
first and second input ports for respective first and second data streams;
a multiplexer for combining said first and second data streams into a common data stream;
a common inverse transform engine for performing an inverse transform operation on said common data stream;
a demultiplexer for separating said transformed common data stream into first and second output data streams; and
first and second output ports for transmitting said output data streams on respective physical channels.

12. The transmitter of claim 11, wherein said first and second input ports comprises mappers for mapping said data streams to a pair of complex vectors {X₁(n)} and {X₂(n)}, and said multiplexer combines said complex numbers into a complex vector for processing in said inverse transform engine.

13. The transmitter of claim 12, wherein said multiplexer combines said complex vectors {X(n)} and {X₂(n)} into one 2N×1 complex vector {X(n)} as follows:
{X(n)}={X₁(n)}+j{X₂(n)}

14. The transmitter of claim 13, wherein said inverse transform engine performs an inverse Fast Fourier Transform to generate a complex vector {x(k)}=IFFT{X(n)}.

15. The transmitter of claim 14, wherein said demultiplexer generates two real vectors {x₁(k)}=Re{x(k)} and {x₂(k)}=Im{x(k)} for input to said respective first and second output ports.

16. The transmitter of claim 12 comprising first and second RAMs associated with said first and second input ports and first and second adders for adding the real and imaginary parts of said data streams from said first and second ports.

17. The transmitter of claim 12, wherein said inverse transform engine is an IFFT engine.

18. A receiver for a multi-carrier communications system comprising:
first and second input ports for receiving first and second input signals on respective physical channels;
a multiplexer for combining said first and second input signals into a common data stream;
a common transform engine for performing an transform operation on said common data stream;
a demultiplexer for separating said transformed data stream into first and second output data streams; and
first and second output ports for outputting said data streams.

19. The receiver of claim 18, wherein said multiplexer combines vectors {x₁(k)}=Re{x(k)} derived from said first and second input signals into a common complex vector.

20. The receiver of claim 19, wherein said multiplexer performs the operation {x(k)}={x₁(k)}+j{x₂(k)}.

21. The receiver of claim 20, wherein said transform engine create a common vector {X(n)}=FFT{x(k)}.

22. The receiver of claim 21, wherein said demultiplexer performs the operation
$$\begin{matrix}{X}_{1}^{′} ( n ) = \{ \begin{matrix}\frac{1}{2} [ X ( 0 ) + {X}^{*} ( 0 ) ] & n = 0 \\ \frac{1}{2} [ X ( n ) + {X}^{*} ( 2 N - n ) ] & n = 1 , … , N - 1\end{matrix} \\ {X}_{2}^{′} ( n ) = \{ \begin{matrix}\frac{1}{2 j} [ X ( 0 ) - {X}^{*} ( 0 ) ] & n = 0 \\ \frac{1}{2 j} [ X ( n ) - {X}^{*} ( 2 N - n ) ] & n = 1 , … , N - 1\end{matrix}\end{matrix}$$

23. The receiver of claim 18 wherein said multiplexer includes RAM.

24. The receiver of claim 23, wherein said transform engine is an FFT.

25. The receiver of claim 24, wherein the output of said transform engine generates real and imaginary signals, said transform engine is connected to a Re-order and Conjugate RAM that generates real and imaginary signals, and said respective real signals from said transform engine and said Re-order and Conjugate RAM are combined in a first pair of adders, and said respective imaginary signals from said transform engine and said Re-order and Conjugate RAM are combined in a second pair of adders, the outputs of the one of the adders of each pair of adders being combined for form said first data stream and the outputs of the other of the adders of each pair being combined to form said second data stream.

26. The receiver of claim 25, wherein said outputs of said one and said other adders of each pair of adders are combined in respective RAMs.

27. The receiver of claim 26, wherein said respective RAMs are coupled to said respective first and second output ports through respective dividers.
